(19) United States
(12) Patent Application Publication
(10) Pub. No.: US 2026/0184590 A1
(43) Pub. Date: Jul. 2, 2026

(54) HIGH-PERFORMANCE PLANARIZING POLISHING PARTICLES AND SLURRY COMPRISING SAME

(71) Applicant: BEAD ORIGIN INC., Seoul (KR)

(72) Inventors: Junghoon NAM, Seoul (KR); Na-Yeon KIM, Seoul (KR)

(21) Appl. No.: 19/128,228

(22) PCT Filed: Nov. 8, 2023
(86) PCT No.: PCT/KR2023/017828

§ 371 Date: May 8, 2025

(30) Foreign Application Priority Data
Nov. 11, 2022 (KR) 10-2022-0150279

(51) Int. Cl. C01F 17/235; C09K 3/14

(52) U.S. Cl. CPC C01F 17/235; C09K 3/1436; C09K 3/1463

(57) ABSTRACT

An inorganic particle according to the present invention has a shape in which a plurality of spherical protrusions are formed on the surface of a spherical primary particle, and is composed of a mixture of amorphous and crystalline phases, and thus the crystallinity of the entire particle is low. In particular, due to these properties, the inorganic particle has greatly increased chemical surface activity on the surface of a nanoparticle while having a large specific surface area. In addition, surface charge control according to pH adjustment is easy. As a result, due to an increase in the efficiency of forming chemical bonds with a silicon film during a semiconductor polishing process, the speed of polishing can be improved, and scratch damage is low, and thus, when used as polishing particles included in a CMP slurry, polishing efficiency is excellent.

### TECHNICAL FIELD

The present invention relates to high-performance planarizing polishing particles, and more specifically, to inorganic nanoparticles having controllable surface chemical properties and low crystallinity, and a method for producing the same. More specifically, the present invention relates to inorganic nanoparticles having a mixture of amorphous and crystalline phases and having a controllable chemical surface activity, and a method for producing the same.

### BACKGROUND ART

Inorganic particles are used as raw materials or final products in various fields, and in particular, they are utilized in a wide range of chemical catalysts, biotechnology, semiconductor processing, and glass tempering.

The process for synthesizing these inorganic particles is very diverse. The synthesis method is divided into physical, mechanical, and chemical methods according to the principle, and is classified into a method of assembling atoms (bottom-up) and a method of reducing the size of a large mass (top-down) according to the manufacturing approach. A top-down method, including the calcination process, is widely used as methods for manufacturing inorganic nanoparticles. However, the top-down method has the disadvantage that the size and shape of the manufactured particles are uneven due to their characteristics. In addition, there is a disadvantage in that the crystallinity of the particles is unusually high and the chemical surface activity is limited due to the high-temperature calcination process. Therefore, a bottom-up colloidal method for manufacturing inorganic particles is required, and the known types of manufacturing processes include a sol-gel method, a pyrolysis method, a polymerized complex method, a precipitation method, and a hydrothermal method.

In the synthesis process, the inorganic particles grow according to the intrinsic atomic assembly characteristics, which in turn leads to the final shape and crystal properties of the particles. Here, the crystal characteristics refer to size of the crystals forming the particles (crystallite size) and crystallinity, which means the ratio of crystalline to non-crystalline (or amorphous). Crystalline refers to a state in which atoms have a regular arrangement, whereas in the amorphous phase, there are many incomplete bonds and broken bonds (unbounded atoms) compared to the crystalline phase. That is, if the amorphous ratio within the particle, especially on the particle surface, is high and the crystallinity is low, unbounded atoms can participate as bond formation sites, which can improve the overall chemical properties. However, as mentioned above, the atomic arrangement structure within the particle is an intrinsic characteristic of the particle, so it is very difficult to control. Nonetheless, in fields using inorganic particles for various chemical reactions, a technology is required that can increase the surface activity of the particles to maximize or accelerate the reaction.

For example, ceria (CeO₂) has a cubic-fluorite atomic arrangement structure, and therefore, it mainly grows as hexagonal particles with a high crystallinity of more than 90% during the particle manufacturing process. Ceria nanoparticles are included as polishing particles in the slurry used in the CMP process in the semiconductor manufacturing process and are used for polishing silica (SiO₂) films. Although the main reaction is to form Ce—O—Si bonds between polishing particles and a film, and the removal rate of the film is the most important index for evaluation of the process performance, it is facing limitations. One way to maximize the removal rate is to increase the surface activity of the polishing particles themselves. However, since this must be controlled from the polishing particle manufacturing process, not the slurry production process, there has been little research on applying low-crystalline particles with maximized surface activity to the CMP process.

Scratch and dishing defects that occur on the wafer surface during the CMP process are another issue. This is due to the angular shape of the polishing particles, and to overcome this, a method for manufacturing spherical ceria particles is being studied, but it is very difficult to synthesize ceria particles that are uniformly sized and well-dispersed while changing the angular cubic-fluorite ceria shape into a spherical shape.

Another method of increasing the surface chemical reaction of inorganic particles is to change the size of the particles. As the particle size decreases, the total surface area tends to increase. If inorganic particles are used as catalysts, the catalytic reaction selectivity of particles with a large specific surface area per unit volume can increase.

Another issue of inorganic particles is dispersion stability. Nano-sized inorganic particles (hereinafter also referred to as ‘nanoparticles’) are generally thermodynamically unstable in an aqueous solution and have difficulties in that they are not stably dispersed due to their high specific surface area. Therefore, there is a problem that agglomeration of the particles may occur during storage, thereby causing change of the shape or properties of the particle. Therefore, there is a need for a method for improving the dispersibility of nanoparticles. Accordingly, in order to improve the dispersibility of nanoparticles, a technique for controlling the surface charge of nanoparticles is required. In particular, for example, dispersion in an aqueous solution of ceria or silica nanoparticles used as abrasive particles in a slurry in a semiconductor CMP process is very important. Therefore, there is an effort to improve the efficiency of the polishing process by adjusting the pH of the aqueous slurry solution to provide an environment capable of generating a stronger attraction between the abrasive particles and the film.

### DETAILED DESCRIPTION OF THE INVENTION

### Technical Problem

The problem to be solved by the present invention is to provide a spherical inorganic particle having a low crystallinity, high surface activity for chemical reactions, excellent water dispersibility, and particularly excellent polishing ability for silicon films, while having a low occurrence of defects such as scratches or dishing.

In addition, another problem to be solved by the present invention is to provide a method for manufacturing the inorganic particle.

In addition, yet another problem to be solved by the present invention is to provide a slurry of dispersion in which the inorganic particles are dispersed in water.

### Solution to Problem

In order to achieve the above-mentioned technical problems, the present invention provides an inorganic particle comprising a primary particle having a solid core and a plurality of secondary particles having a diameter smaller than that of the primary particle and forming protrusions on the surface of the primary particle, wherein the inorganic particle has a specific surface area of 60 to 150 m²/g, surface-active sites occupying 40 to 60% of the inorganic particle surface as obtained from an element content calculated by X-ray photoelectron spectroscopy, and a total surface activity of 50 to 90% defined as the percentage of active sites to inactive sites on the surface of the inorganic particle.

According to one embodiment, the secondary particles protrude from the surface of the primary particle but are not separated therefrom, and the interior of the primary particle has a solid form without any empty space.

According to one embodiment, the solid primary particle may be grown in a shell formed by a self-assembling surfactant together with a catalyst.

According to one embodiment, the catalyst may be at least one inorganic catalyst selected from sulfuric acid, hydrochloric acid, nitric acid, potassium hydroxide, sodium hydroxide, calcium hydroxide, magnesium hydroxide, ammonia, and EDTA including Fe-EDTA, EDTA-2Na, EDTA-2K, and the like, and phosphates including potassium carbonate (K₂CO₃), potassium dihydrogen phosphate (KH₂PO₄), potassium monohydrogen phosphate (K₂HPO₄), sodium carbonate (Na₂CO₃), sodium dihydrogen phosphate (NaH₂PO₄), and sodium monohydrogen phosphate (Na₂HPO₄).

According to one embodiment, the inorganic particle may have a density of 1.5 to 7.5 g/ml and an average diameter of 30 to 1000 nm.

According to one embodiment, the secondary particle has a diameter of 2 to 25% of the diameter of the primary particle.

According to one embodiment, the inorganic particle may be composed of a mixture of a crystalline phase and a non-crystalline (amorphous) phase and has a degree of crystallinity of 50 to 90%.

According to one embodiment, the inorganic particle may have a zeta potential of +30 to +50 mV or −30 to −50 mV in an aqueous dispersion at pH 4.

According to one embodiment, the primary particle and the secondary particle may each independently be composed of an oxide of one or more selected from the group consisting of Ga, Sn, As, Sb, Ce, Si, Al, Co, Fe, Li, Mn, Ba, Ti, Sr, V, Zn, La, Hf, Ni and Zr.

In addition, in order to solve other technical problems as mentioned above, the present 20 invention provides a method comprising the steps of:
(a) dissolving a self-assembling surfactant and a catalyst in a solvent;
(b) dissolving or dispersing an inorganic precursor in the solvent before, after, or simultaneously with the step (a) to prepare an inorganic precursor solution; and
(c) forming a solid primary particle in a shell formed through a self-assembly reaction between the inorganic precursor and the surfactant, and then forming a plurality of secondary particles having a diameter smaller than that of the primary particle as protrusions on the surface of the primary particle.

According to one embodiment, the self-assembling surfactant is at least one selected from a cationic surfactant, an anionic surfactant and an amphoteric surfactant, having a charge capable of ionically bonding with the inorganic precursor and having a functional group capable of a condensation reaction or cross-linking reaction.

According to one embodiment, the functional group capable of the condensation reaction or cross-linking reaction may be at least one selected from the group consisting of an amido group, a nitro group, an aldehyde group, and a carbonyl group.

According to one embodiment, the self-assembling surfactant may be a polymer of the following chemical formula 1:

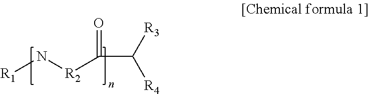

wherein, R₁, R₃, and R₄ are each independently a hydrogen atom, a C₁-C₁₀ alkyl group, or an alkoxy group, R₂ is a C₂-C₁₀ alkylene group or a single covalent bond, and n is an integer greater than or equal to 2.

According to one embodiment, the method may further comprise treating the inorganic particle obtained in step (c) with an acid and a base to obtain the inorganic particle having a controlled surface charge.

According to one embodiment, the solvent may be water or a mixed solvent of water and a solvent compatible with water.

According to one embodiment, R₁ and R₂ in the chemical formula 1 may each be a C₁-C₃ alkyl group.

According to one embodiment, the solvent having compatibility with water may be at least one selected from alcohol, chloroform, ethylene glycol, propylene glycol, diethylene glycol, glycerol, and butylene glycol.

In addition, according to the present invention, an aqueous dispersion in which the above-mentioned inorganic particles are dispersed in water is provided.

In addition, the present invention provides a slurry for CMP containing the aqueous dispersion.

### Effect of the Invention

The inorganic particle according to the present invention has a shape in which a plurality of spherical protrusions is formed on the surface of a spherical primary particle, and is composed of a mixture of amorphous and crystalline phases, and thus the crystallinity of the entire particle is low. In particular, due to these properties, the inorganic particle has greatly increased chemical surface activity on the surface of a nanoparticle while having a large specific surface area. In addition, surface charge control according to pH adjustment is easy. As a result, due to an increase in the efficiency of forming chemical bonds with a silicon film during a semiconductor polishing process, the removal rate can be improved, and scratch damage is low, and thus, when used as polishing particles included in a CMP slurry, polishing efficiency is excellent.

### BRIEF DESCRIPTION OF THE DRAWINGS

FIG. 1 schematically illustrates the shape, crystal structure, and surface characteristics of inorganic particles according to the present invention.

FIG. 2 shows field-emission scanning electron microscopic images of well-dispersed samples of three sized spherical protrusion CeO₂ nanoparticles manufactured according to Reference Example 1 and Examples 1 and 2.

FIG. 3 shows high-resolution transmission electron microscopic images of well-dispersed samples of three sized spherical protrusion CeO₂ nanoparticles manufactured according to Reference Example 1, and Examples 1 and 2.

FIG. 4 shows high-resolution transmission electron microscopic images of CeO₂ nanoparticle sample having an angular shape according to Comparative Example 1.

FIG. 5 shows high-resolution transmission electron microscopic images of CeO₂ nanoparticle sample having an angular shape according to Comparative Example 2.

FIG. 6 shows an X-ray diffraction (XRD) pattern for ceria nanoparticles according to Reference Example 1, Examples 1 and 2, and Comparative Examples 1 and 2.

FIG. 7 shows an X-ray photoelectron spectroscopy (XPS) pattern for three sized spherical protrusion CeO₂ nanoparticle samples manufactured according to Reference Example 1 and Examples 1 and 2.

FIG. 8 shows an X-ray photoelectron spectroscopy (XPS) pattern for three sized CeO₂ nanoparticle samples according to Reference Example 1 and Comparative Examples 1 and 2.

FIG. 9 shows the results of measuring the zeta potential after adjusting the pH of the aqueous dispersion of ceria nanoparticle according to Example 2.

FIG. 10 shows the results comparing the removal rates of silicon films using the slurries of Manufacturing Examples 1 to 3.

### BEST MODE FOR CARRYING OUT THE INVENTION

Hereinafter, the present invention will be described in more detail with reference to various embodiments. However, this is not intended to limit the present invention to specific embodiments, but should be understood to include all modifications, equivalents, or substitutes included in the technical spirit and scope of the present invention.

Terms such as first, second, A, and B may be used to describe various components, but the components are not limited by the terms, and the terms are used only for the purpose of distinguishing one component from other components.

The term “and/or” includes any one or any combination of a plurality of recited items.

When a component is referred to as being “connected” or “contacted” to another component, it should be understood that it may be connected or contacted to another component directly or with other component interposed therebetween.

The singular expression includes the plural expression unless otherwise specified.

Terms such as “comprise”, “include” or “have” refer to the presence of a feature, number, step, operation, component, part, or combination thereof described in the specification, and do not exclude the possibility that other features, figures, steps, operations, components, parts, or combinations thereof not mentioned herein may exist or be added.

According to the present invention, by reacting a self-assembling surfactant with an inorganic precursor in an aqueous solvent, it is possible to synthesize inorganic particles having a shape other than a particle shape according to the intrinsic atomic assembly characteristics of the inorganic substance. For example, ceria (CeO₂) inorganic particles formed in an angular cubic-fluorite hexagonal structure according to their intrinsic atomic assembly structure, can be manufactured as spherical protrusion particles with a mixture of amorphous and crystalline phases.

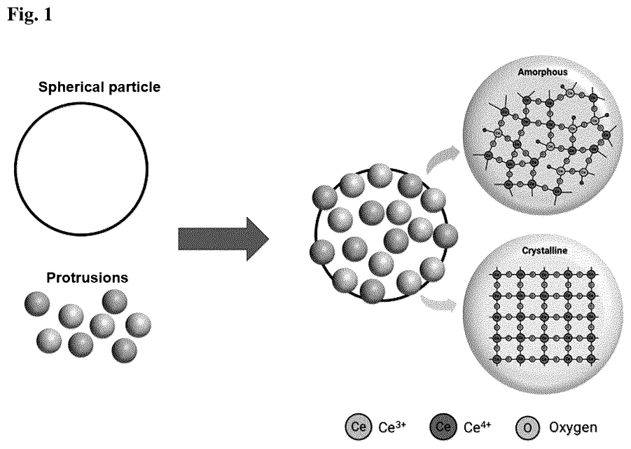

As shown in FIG. 1, the inorganic particle according to the present invention has a plurality of secondary particles having a diameter (d) smaller than the diameter (D) of a primary particle and forming protrusions on the surface of the solid primary particle.

Additionally, the shape of the primary particles and the protrusions formed by the secondary particles are all substantially spherical and solid. Here, the term spherical means that the aspect ratio, expressed as the ratio of the short diameter to long diameter, is 0.8 or more, 0.9 or more, or 0.95 or more, and its reciprocal is 1.2 or less, 1.1 or less, or 1.05 or less. Therefore, the inorganic particle according to the present invention is hereinafter also referred to as a “spherical protrusion inorganic particle” or “spherical protrusion nanoparticle”.

Since the nano-sized inorganic particles have spherical protrusions on their surface, there is an effect that the specific surface area of the particles based on the same mass can be increased. The diameter of the secondary particle forming the spherical protrusion is 2 to 25% of the diameter of the primary particle. Preferably, it may be 2% or more, 20% or less, 15% or less, 10% or less, or 5% or less.

The spherical protrusion inorganic particle according to the present invention has a narrow particle size distribution of 30 to 1000 nm and a uniform size. The size of the spherical protrusion inorganic particle is based on the number average particle size, and may be preferably 40 nm or more, 60 nm or more, 80 nm or more, 100 nm or more, 110 nm or more, or 120 nm or more, and 800 nm or less, 500 nm or less, 300 nm or less, 200 nm or less, or 150 nm or less.

The spherical protrusion inorganic particles according to the present invention are manufactured by a self-assembling reaction of a self-assembling surfactant and an inorganic precursor, thereby obtaining a solid primary particle. As a result, the inorganic particles according to the present invention have a density of 1.5 to 7.5 g/ml. The density may be measured using a TAP density measurement method (ASTM B527). The density of the inorganic particles may be 3.2 g/ml or more, 3.3 g/ml or more, 3.4 g/ml or more, or 3.5 g/ml or more, and 4.5 g/ml or less, or 4.0 g/ml or less.

The spherical protrusion inorganic particle according to the present invention may be composed of a mixture of crystalline and non-crystalline (amorphous) phases. Additionally, the primary particle and secondary particle may also be crystalline or non-crystalline (amorphous). The crystallinity is calculated as “crystalline/(crystalline+non-crystalline)×100” and may be obtained through the results obtained by X-ray diffraction analysis (XRD). As a result, the overall crystallinity may be greater than or equal to 50%, greater than or equal to 60%, or greater than or equal to 70%, and less than or equal to 80% or less than or equal to 90%.

The spherical protrusion inorganic particle according to the present invention, particularly the surface of the particle, is composed of a chemically active site and an inactive site. For example, in ceria (CeO₂), Ce³⁺ and Ce⁴⁺ are the active and inactive sites, respectively. The active sites (Ce³⁺ in the case of CeO₂) may be 40% or more, 50% or less, or 60% or less based on the entire particle surface. The surface activity, which refers to the active site to the inactive site on the particle surface (Ce³⁺/Ce⁴⁺ in the case of CeO₂), may be 50% or more or 60% or more, and 70% or less, 80% or less, or 90% or less.

The specific surface area of the spherical protrusion inorganic particle according to the present invention may be 60 m²/g or more, 80 m²/g or more, or 100 m²/g or more, and 110 m²/g or less, 130 m²/g or more, or 150 m²/g or less.

According to one embodiment, the primary particle and the secondary particle may each independently be composed of an oxide of one or more inorganic substances selected from the group consisting of Ga, Sn, As, Sb, Ce, Si, Al, Co, Fe, Li, Mn, Ba, Ti, Sr, V, Zn, La, Hf, Ni and Zr. In a preferred embodiment, it may be an oxide of one or more selected from cerium (Ce), silicon (Si) and aluminum (Al).

According to one embodiment, the spherical protrusion inorganic particle may have a surface charge of at least +30 mV or higher, or −30 mV or lower in an aqueous dispersion, and in particular, may exhibit a surface charge (zeta potential) having a high absolute value of +30 to +50 mV or −30 to −50 mV under pH 4 conditions. Here, the term ‘surface charge’ is used interchangeably with ‘zeta potential’.

In addition, according to the present invention, an aqueous dispersion in which the above-mentioned inorganic particles are dispersed in water is provided.

If the spherical protrusion nanoparticles according to the present invention are used as polishing particles in the slurry in the semiconductor CMP process, scratch defects can be compensated for by using spherical particles without sharp angles. Due to the numerous protrusions on the particle surface, the specific surface area increases, which not only increases the probability of contact with the film to be polished but also improves the polishing rate due to the change in the surface properties of the particles. If ceria with a smaller particle size and a more active surface is used as the polishing particle, the polishing rate can be further maximized. For example, in the case of spherical protrusion ceria nanoparticles manufactured by the method suggested in the present invention, the polishing rate may be improved because the amount of Ce(III) increases compared to conventional hexagonal fluorite ceria particles due to elemental defects on the particle surface.

In addition, according to the method for controlling the surface charge of inorganic nanoparticle through pH adjustment suggested in the present invention, it is possible to more easily control the surface charge of the spherical protrusion nanoparticle. In addition, a pH environment of an aqueous solution that can provide an optimal interaction between abrasive particles and the film in the CMP process can be used for more efficient and stable polishing.

Hereinafter, a method for manufacturing spherical protrusion inorganic particles using a liquid synthesis method according to the present invention will be described in more detail.

Method for Manufacturing Spherical protrusion Inorganic Particle Using Liquid-Phase Synthesis

The spherical protrusion inorganic particle according to the present invention may be manufactured by a method comprising the following steps of:
(a) dissolving a self-assembling surfactant and a catalyst in a solvent;
(b) dissolving or dispersing an inorganic precursor in the solvent before, after, or simultaneously with the step (a) to prepare an inorganic precursor solution; and
(c) forming a solid primary particle in a shell formed through a self-assembly reaction between the inorganic precursor and the surfactant, and then forming a plurality of secondary particles having a diameter smaller than that of the primary particle as protrusions on the surface of the primary particle.

In the method for manufacturing spherical protrusion inorganic particle using the liquid-phase synthesis of the present invention, the step (c) of the particle formation comprises (i) producing spherical inorganic particles through a self-assembly reaction of a self-assembling surfactant and an inorganic precursor in the presence of a catalyst; and (ii) forming surface protrusions on the surface of spherical inorganic particle as the self-assembly reaction progresses. Although the two stages of inorganic particle formation and surface protrusion formation have been described separately, it can also be seen that the spherical protrusion inorganic particle is formed by a single synthesis step because the reactions occur continuously.

### Inorganic Precursor

First, a precursor solution of an inorganic material to be prepared is prepared. The solution is prepared by mixing an inorganic precursor, a self-assembling surfactant, and a solvent. The surfactant may be first dissolved in the solvent and then the inorganic precursor may be added, or the inorganic precursor may be first dissolved in the solvent and then the surfactant may be added and mixed. Alternatively, the inorganic precursor and the self-assembling surfactant may be simultaneously added to the solvent and mixed. In this process, a weak bond is formed between the inorganic precursor and the surfactant.

Here, the inorganic precursor is a material capable of forming an oxide, which contains one or elements selected from the group consisting of Ga, Sn, As, Sb, Ce, Si, Al, Co, Fe, Li, Mn, Ba, Ti, Sr, V, Zn, La, Hf, Ni and Zr. It is preferable that the inorganic precursor used in the present invention is a compound capable of ionically bonding with the charged surfactant in an aqueous solution state. For example, it may be nitrate, bromide, carbonate, chloride, fluoride, hydroxide, iodide, oxalate or sulfate, which may be in the form of a hydrate or anhydride.

More specifically, for example, a cerium-containing salt may be used, for example ammonium cerium(IV) nitrate, cerium(III) bromide anhydrous, cerium(III) carbonate hydrate, cerium(III) chloride anhydrous, cerium(III) chloride heptahydrate, cerium(III) fluoride anhydrous, cerium(IV) fluoride, cerium(IV) hydroxide, cerium(III) iodide anhydrous, cerium(III) nitrate hexahydrate, cerium(III) oxalate hydrate, cerium(III) sulfate, cerium(III) sulfate hydrate, cerium(III) sulfate octahydrate and cerium(IV) sulfate hydrate.

Alternatively, silicon precursors such as tetraethyl orthosilicate (TEOS), diethoxydimethylsilane (DEMS) and vinyltriethoxysilane (VIES), titanium precursors having a structure of Ti(OR)₄, zirconium precursors having a structure of Zr(OR)₄, aluminum precursors having a structure of Al(OR)₄ may be used. Here, R denotes a functional group that can be hydrated or alcoholized with water or alcohol, for example, a lower alkyl group such as a methyl group or an ethyl group. In addition, it is also possible to use a precursor capable of forming an oxide of Ga, Sn, As, Sb, Mn, or V.

### Self-Assembling Surfactant

Surfactants that are capable of self-assembling include anionic, cationic, and amphoteric surfactants which have a functional group capable of combining with the inorganic precursor, having a (+) charge, a (−) charge or both charges when dissolved in a solvent and inducing a particle formation by a crosslinking reaction. Examples of the functional group include an amido group, a nitro group, an aldehyde group, and a carbonyl group.

According to the present invention, it is possible to prepare particles having different surface charges depending on the type of the self-assembling surfactant used in the synthesis reaction. That is, the self-assembling surfactant may be selectively used according to the surface charge of the inorganic particle to be synthesized. For example, a cationic surfactant can be used when preparing spherical protrusion inorganic particles having a (−) charge. The positive (+) charged sites of the cationic surfactant combines with ions of the inorganic precursor to form inorganic nanoparticles, and as the reaction proceeds, a self-assembled shell is formed, in which inorganic particles grow in a spherical shape with protrusions on the surface. According to the same principle, on the contrary, an anionic surfactant can be used when preparing spherical protrusion inorganic particles having a (+) charge. As such, in order to prepare inorganic particles having a target surface charge, a surfactant shell having a specific ionicity is required. It is possible to manufacture particles having a different surface charge according to the type of the self-assembling surfactant used.

In addition, if necessary, one or more surfactants may be mixed and used during the synthesis process. Among the self-assembling materials, surfactants can form crosslinking with each other while being dissolved in a solvent and can be self-assembled as the reaction proceeds at a certain temperature and over a certain time. At this time, the distance between the fine nanoparticles bound to the surfactant becomes closer, resulting in aggregation of the particles to grow up the particles. As the particle grows surrounded by the shell of the self-assembled surfactant, the particle is formed into a solid spherical particle, and at the same time numerous protrusions are formed on its surface. The protrusions may grow simultaneously on the surface of the spherical particle, or the protrusions may grow individually and be exposed on the surface of the spherical particle.

As the anionic surfactant, alkylbenzene sulfonates, alkyl sulfates, alkyl ether sulfates, soaps, poly acrylic-acid, poly(acrylic acid-co-itaconic acid), poly(acrylic acid-co-maleic acid), etc. may be used.

As the cationic surfactant, an alkyl quaternary nitrogen compound, a quaternary ammonium compound such as Esterquats may be used.

Also, an amphoteric surfactant containing both of cationic quaternary ammonium ionic groups and anionic carboxylate (—COO⁻), sulfate (—SO₄²⁻) or sulfonate (—SO₃⁻) groups may be used.

In addition, examples include compounds having nitrogen atoms in their molecular structures, such as picolinic acid, nicotinic acid, 2,3-pyridinedicarboxylic acid, glutamic acid, aspartic acid, and arginine, and compounds not having nitrogen atoms, such as oxalic acid, malic acid, fumaric acid, lactic acid, suberic acid, 2-ethylbutyric acid, citric acid, and quinic acid.

Also, (carboxymethyl)dimethyl-3-[(1-oxododecyl)amino]propylammonium hydroxide, lauryl betaine, betaine citrate, sodium lauroamphoacetate, sodium hydroxymethylglycinate, (carboxymethyl)dimethyloleylammonium hydroxide, cocamidopropyl betaine, (carboxylate methyl)dimethyl(octadecyl)ammonium, PEO-PPO block copolymer, anionic siloxanes and dendrimers, poly(sodium 10-undecylenate), poly(sodium 10-undecenylsulfate), poly(sodium undeconylvalinate), polyvinylpyrrolidone, polyvinylalcohol, 2-acrylamide-2-methyl-1-propanesulfonic acid, alkyl methacrylamide, alkyl acrylate, poly(allylamine)-supported phases, poly(ethyleneimine), poly(N-isopropylacrylamide), n-hydroxysuccinimide, poly-diallyldimethylammonium chloride, sodium dodecyl sulfate, sodium dodecyl benzene sulfonate, cetrimonium bromide, benzalkonium chloride, sodium lauroyl sarcosinate, methyl triethanol ammonium methyl sulfate distearyl ester, etc. may be used.

Preferably, the self-assembling surfactant may be a polymer of the following chemical formula 1. In addition, the polymer of the following formula 1 may be an amphoteric surfactant having both (+) and (−) charges in the molecule.

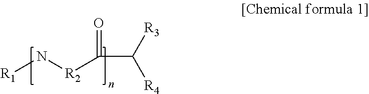

wherein, R₁, R₃, and R₄ are each independently a hydrogen atom, a C₁-C₁₀ alkyl group, or an alkoxy group, R₂ is a C₂-C₁₀ alkylene group or a single covalent bond, and n is an integer greater than or equal to 2.

It is preferable that the polymer of the chemical formula 1 has a molecular weight of 500 or more and 100,000 or less. Here, the molecular weight is a weight average molecular weight, and the weight average molecular weight means a polystyrene equivalent molecular weight measured by the GPC method. The molecular weight of the polymer may be 1000 or more, 5000 or more, 10,000 or more, 20,000 or more, or 30,000 or more, and 95,000 or less, 90,000 or less, 85,000 or less, 80,000 or less, 70,000 or less, 60,000 or less, 50,000 or less, or 40,000 or less.

The amount of the self-assembling surfactant used may be 30 to 150 parts by weight per 100 parts by weight of the inorganic precursor. The amount of the surfactant used may be 40 parts by weight or more, 50 parts by weight or more, 60 parts by weight or more, 70 parts by weight or more, 80 parts by weight or more, or 90 parts by weight or more, and 140 parts by weight or less, 130 parts by weight, 120 parts by weight or less or 110 parts by weight or less.

According to a preferred embodiment of the present invention, the self-assembling surfactant may be used together with poly(N-isopropylacrylamide) and a nitrogen atom-containing compound selected from picolinic acid, nicotinic acid, 2,3-pyridinedicarboxylic acid, glutamic acid, aspartic acid, and arginine. At this time, the weight ratio of poly(N-isopropylacrylamide) and the nitrogen atom-containing compound can be 1:0.5 to 2 or 1:0.5 to 1.5.

### Catalyst

Inorganic catalysts can be used together with the above self-assembling surfactants. By adjusting the pH of the synthetic solution with an inorganic catalyst, the growth rate of the particles can be controlled by changing the mutual repulsion or attraction according to the charge of the self-assembling surfactant.

For example, lowering the pH of the synthetic solution containing a cationic self-assembling surfactant using an inorganic catalyst can enhance the (+) properties of the self-assembling surfactant. This increases the repulsion between self-assembling surfactants during the particle synthesis process in which the particles grow based on the principle of bringing fine nano-inorganic particles closer together, thereby slowing down the overall particle aggregation.

Examples of the above inorganic catalysts include acidic substances such as sulfuric acid, hydrochloric acid, and nitric acid; basic substances such as potassium hydroxide, sodium hydroxide, calcium hydroxide, magnesium hydroxide, and ammonia; EDTA substances including Fe-EDTA, EDTA-2Na, and EDTA-2K; and phosphates including potassium carbonate (K₂CO₃), potassium dihydrogen phosphate (KH₂PO₄), potassium monohydrogen phosphate (K₂HPO₄), sodium carbonate (Na₂CO₃), sodium dihydrogen phosphate (NaH₂PO₄), and sodium monohydrogen phosphate (Na₂HPO₄).

The amount of inorganic catalyst used to control the growth rate of particles may be 30 to 150 parts by weight per 100 parts by weight of self-assembling surfactant. The amount of catalyst used may be 40 parts by weight or more, 50 parts by weight or more, 60 parts by weight or more, 70 parts by weight or more, 80 parts by weight or more, or 90 parts by weight or more, and 140 parts by weight or less, 130 parts by weight or less, 120 parts by weight or less, or 110 parts by weight or less, per 100 parts by weight of the self-assembling surfactant.

### Solvent

The solvent used for the synthesis reaction of the spherical protrusion inorganic particle may be water or a mixed solvent of a solvent having compatibility with water and water.

According to one embodiment, the solvent having compatibility with water may be at least one selected from alcohol, chloroform, ethylene glycol, propylene glycol, diethylene glycol, glycerol, and butyl glycol.

When the solvent having compatibility with water is mixed with water, the mixing volume ratio of water:solvent may be 100:50-200, or 100:60-150, or 100:70-120.

When dissolving an inorganic precursor and/or a self-assembling surfactant in a water or a mixture of water and a solvent compatible with water, it is better to use a stirrer and to proceed with the reaction after complete dissolution. If not, the formation of particles having a uniform morphology may be inhibited.

### Synthesis of Inorganic Particle and Surface Activity Control Method

In synthesizing the spherical protrusion inorganic particle, the previously prepared inorganic precursor solution is introduced into a reactor to perform a synthesis reaction with the self-assembling surfactant. The synthesis of the spherical protrusion inorganic particle is carried out at a temperature range of 60 to 250° C. for 1 to 24 hours. Preferably it is carried out at a temperature range of 70° C. or more, 80° C. or more or 90° C. or more and 220° C. or less, 200° C. or less, or 180° C. or less, or 160° C. or less for 2 hours or more, 3 hours or more, or 4 hours or more and 20 hours or less, 10 hours or less, or 8 hours or less.

As the reaction proceeds at a certain temperature for a certain period after the self-assembling surfactant was dissolved in a solvent, the self-assembling surfactant is combined with the ions of the inorganic precursor. Here, the term self-assembly means that positively (+) charged moieties and negatively (−) charged moieties of the surfactant are combined to spontaneously form an organized structure or shape. For example, if the surfactant has an amido group of which the nitrogen atom moiety has a (+) charge and the oxygen atom moiety has a (−) charge in the molecular structure, it can form a network structure by itself. At the same time, the distance between the fine nanoparticles which are dissolved in the solvent together with these self-assembling materials becomes closer, resulting in aggregation of the particles to grow up the particles. In this process, as the particles grow surrounded by the shell of the surfactant, the spherical particle is formed, and secondary particles are formed as protrusions on the surface of the spherical particle. The protrusions may grow simultaneously on the surface of the spherical particle, or the protrusions may grow individually and be exposed on the surface of the spherical particle. At this time, the overall protrusion or particle 15 may be composed of an amorphous or crystalline phase, or a mixture thereof. Accordingly, the overall crystallinity of the particles may be between 50 and 90%. The chemically active sites of the particles (in the case of ceria particles, the chemically active site is Ce³⁺) occupy 40 to 60% of the particle surface, and the total surface activity, defined as “active site/inactive site×100” (in the case of ceria particles, defined as “Ce³⁺/Ce⁴⁺×100”), may be 50 to 90%.

Surface Charge Control Method of Spherical protrusion Inorganic Particle

According to the present invention, the surface charge of the inorganic particle can be controlled by treating the inorganic particle obtained in the synthesis reaction with an acid and/or a base.

The method for controlling the surface charge of the spherical protrusion inorganic particle presented in the present invention is basically to control the pH of the aqueous solution containing the particles. For example, in the case that there are positively charged particles in an aqueous solution, as an acidic substance is added, the particles become highly positively charged. Conversely, as a basic substance is added, the surface charge of the particles becomes weakly positive and then will reach neutral point. If excess bases are continuously added, the particles will be negatively charged. Using this principle, it is possible to control the surface charge of the inorganic particle by adjusting the pH of the aqueous solution.

As an acidic pH adjusting agent for lowering the pH of the aqueous solution, acidic substances such as phosphoric acid, hydrochloric acid, nitric acid, and sulfuric acid may be used alone or in combination of two or more. Conversely, as a basic pH adjusting agent for increasing the pH, basic substances such as sodium hydroxide and ammonia water may be used alone or in combination of two or more. Additionally, EDTA substances such as Fe-EDTA, EDTA-2Na, EDTA-2K, etc. may be used alone or in combination of two or more. Additionally, one or more phosphates such as potassium carbonate (K₂CO₃), potassium dihydrogen phosphate (KH₂PO₄), potassium monohydrogen phosphate (K₂HPO₄), sodium carbonate (Na₂CO₃), sodium dihydrogen phosphate (NaH₂PO₄), and sodium monohydrogen phosphate (Na₂HPO₄) may be used alone or in combination of two or more. At this time, accurate measurement of pH can be achieved by uniformly mixing the inside of the aqueous solution using a stirrer while adjusting pH.

The spherical protrusion inorganic particle according to the present invention has a surface charge of +30 mV or more, or −30 mV or less at least once and has a stable state in the aqueous solution. Thus, a method for controlling surface charge that can exhibit surface properties more effectively is provided. The resulting particles have excellent bonding strength with various media such as glass and silicone, so they can be used as abrasive particles.

In particular, the inorganic particle according to the present invention may have a surface charge of +30 to +50 mV or −30 to −50 mV in an aqueous solution of pH 4. That is, due to a zeta potential having a high absolute value under a given pH condition, the removal rate may be further improved. Here, the term‘surface charge’ is used interchangeably with ‘zeta potential’.

### Embodiments for Carrying Out the Invention

### Example

The configuration and operation of the present invention will be described in more detail through the following examples. However, they are presented as preferred embodiments of the present invention and cannot be construed as limiting the present invention in any sense.

In addition, descriptions that can be technically inferred by those skilled in the art will be omitted.

### Manufacturing of Spherical Protrusion Ceria Nanoparticle

### Reference Example 1

In 160 ml of a solvent in which ethylene glycol (99%) and water were mixed at a volume ratio of 100:100, 2 g of poly(N-isopropylacrylamide) (Aldrich, Mw: 30,000) as a self-assembling surfactant was added and stirred with a magnetic stirrer. After confirming complete dissolution, 2 g of cerium nitrate hexahydrate (Ce(NO₃)₃·6H₂O) from Aldrich as a cerium precursor was added and dissolved to prepare a cerium precursor solution.

The cerium precursor solution was put into a liquid phase reactor where the temperature was maintained, and the synthesis reaction was carried out for about 165 minutes in a temperature range of 90 to 140° C. After completion of the reaction, the obtained ceria particle solution was centrifuged at 4000 rpm for 1 hour and 30 minutes using a centrifuge, the precipitate was separated and then washed 3 times with water (H₂O) to obtain the resultant ceria nanoparticle (M10).

### Example 1

2 g of poly(N-isopropylacrylamide) (Aldrich, Mw: 40,000) having a molecular weight different from that used in Reference Example 1 and 1 g of nicotinic acid were added and stirred at 70 to 90° C. for 6 hours. In addition, ceria nanoparticles (S70) were manufactured in the same manner as in Reference Example 1, except that 10 g of a 1 M aqueous nitric acid solution as an inorganic catalyst was added together with the self-assembling surfactant to adjust the pH to 4 or lower.

### Example 2

2 g of poly(N-isopropylacrylamide) (Aldrich, Mw: 85,000) having a molecular weight different from that used in Reference Example 1 and 3 g of nicotinic acid were added and stirred at 70 to 90° C. for 6 hours. In addition, ceria nanoparticles (S40) were manufactured in the same manner as in Reference Example 1, except that 5 g of a 1 M aqueous nitric acid solution as an inorganic catalyst was added together with the self-assembling surfactant to adjust the pH to 4 or lower.

### Comparative Example 1

CeO₂ particles having a fluorite hexagonal structure (manufacturer: Solvay, product name: HC60) were prepared.

### Comparative Example 2

CeO₂ particles having a fluorite hexagonal structure (manufacturer: Cabot electronics, product name: D7400) were prepared.

### Preparation of Slurry

### Manufacturing Example 1

The ceria nanoparticles obtained in Reference Example 1 were dispersed again in water at a concentration of 0.3 wt % and the pH was optimized to pH 4 to obtain a slurry (a).

### Manufacturing Example 2

The ceria nanoparticles obtained in Example 2 were dispersed again in water at a concentration of 0.3 wt % and the pH was optimized to pH 4 to obtain a slurry (b).

### Manufacturing Example 3

Fluorite hexagonal CeO₂ nanoparticles of Comparative Example 1 were dispersed in water at a concentration of 0.3 wt % and the pH was optimized to pH 4 to obtain a slurry (c).

### Evaluation of Physical Properties

### FESEM (Field-Emission Scanning Electron Microscope) Observation

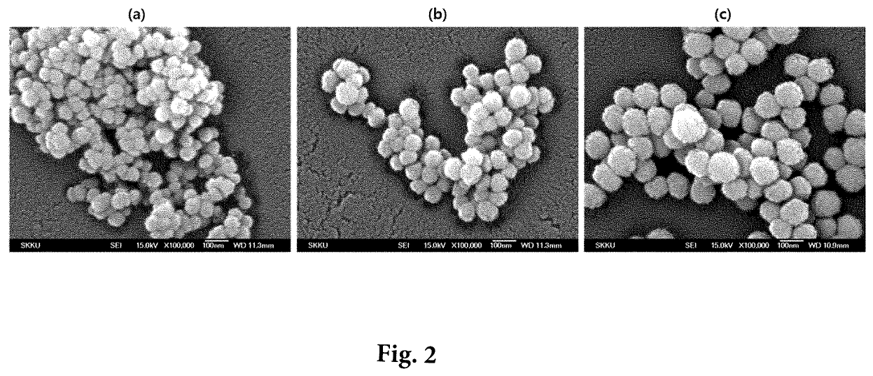

FIGS. 2(a),(b), and(c) show field-emission scanning electron microscopic images of well-dispersed samples of three sized spherical protrusion CeO₂ nanoparticles manufactured according to Reference Example 1 and Examples 1 and 2. It can be confirmed that the nano-sized CeO₂ particles are spherical in shape, have protrusions on the particle surface, and the particles are all evenly distributed with a relatively uniform size.

### High-Resolution Transmission Electron Microscope (HRTEM) Observation

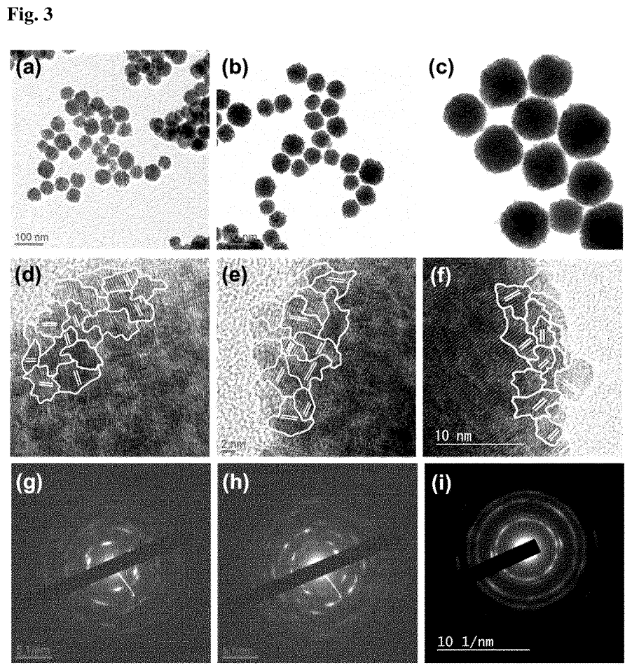

FIG. 3 shows a high-resolution transmission electron microscope image of ceria nanoparticles. (a), (d), and (g) correspond to Example 2, (b), (e), and (h) correspond to Example 1, and (c), (f), and (i) correspond to Reference Example 1. The CeO₂ nanoparticles are spherical in shape, all three particles have protrusions on their surfaces, and the particles are all evenly distributed with relatively uniform sizes. In particular, it is found that the crystals constituting the particles have a size of approximately 5 nm, and it is confirmed that each is crystalline or amorphous. Additionally, all three SAED patterns show that the particles are a mixture of crystalline and amorphous phases.

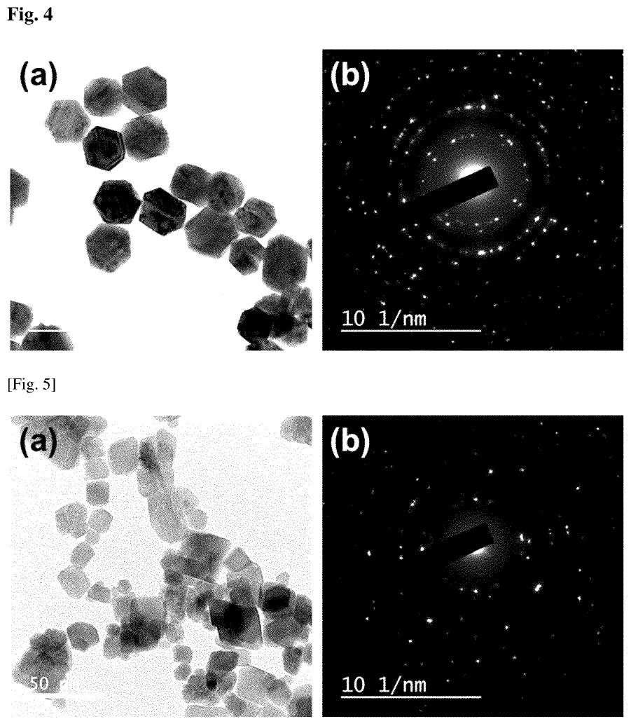

FIG. 4 shows a high-resolution transmission electron microscope image of the sample according to Comparative Example 1. The particles are relatively uniform in size but have an angular cubic-fluorite shape. Additionally, the SAED pattern shows that the particles are mostly composed of crystalline substances.

FIG. 5 shows a high-resolution transmission electron microscope image of a sample according to Comparative Example 2. It is found that the particles are irregular in shape and are partially aggregated. Additionally, the SAED pattern shows that the particles are mostly composed of crystalline substances.

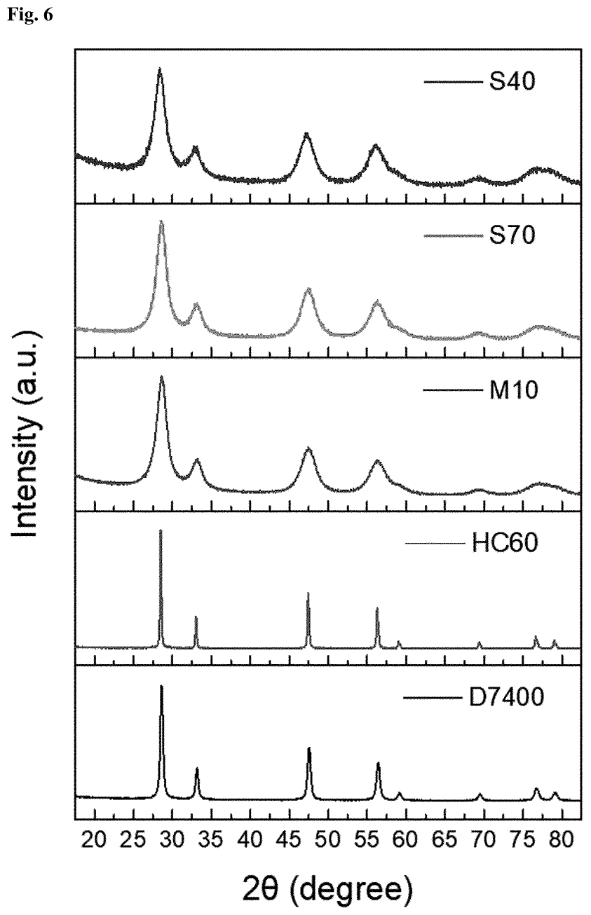

FIG. 6 is an X-ray diffraction (XRD) pattern for ceria nanoparticles according to Reference Example 1, Examples 1 and 2, and Comparative Examples 1 and 2. Table 1 shows the results of measurements of full width of half maximum (FWHM), crystallite size, crystallinity, and BET surface area.

TABLE 1

| | FWHM | Crystallite size | Crystallinity | BET Surface area |
|---|---|---|---|---|
| | (degree) | (nm) | (%) | (m²/g) |
| S40 | 1.52 | 5.40 | 70.9 | 136.2 |
| S70 | 1.40 | 5.86 | 70.3 | 96.6 |
| M10 | 1.88 | 4.36 | 70.5 | 53.5 |
| HC60 | 0.18 | 45.5 | 95.8 | 10.6 |
| D7400 | 0.40 | 20.5 | 94.9 | 11.2 |

As can be seen from the results in Table 1 above, it can be seen that the particles S40, S70, and M10 according to the present invention all have lower crystallinity and larger specific surface areas than the two ceria nanoparticles of Comparative Examples 1 and 2. In addition, it can be seen that the specific surface area of the three CeO₂ particles, S40, S70, and M10, increases as the particle size decreases.

### Density and Average Particle Size

The density of CeO₂ inorganic particles according to Reference Example 1, Examples 1 and 2, and Comparative Examples 1 and 2 was measured using the TAP density measurement method (ASTM B527), and the particle size was measured using a dynamic Light scattering device (Nano ZS) manufactured by Malvem and a high-resolution transmission electron microscope. Here, the particle size refers to the average particle size of the entire particle including protrusions. The measurement results are shown in Table 2.

TABLE 2

| | | | Surface | |
|---|---|---|---|---|
| | | Average particle | protrusion | |
| | Density | size | diameter | |
| | (g/ml) | (nm) | (nm) | Shape |
| Reference | 3.6 | 108 | 4.36 | Uniform |
| Example 1 | | | | spherical |
| | | | | particle with |
| | | | | surface |
| | | | | protrusions |
| Example 1 | 3.5 | 68.6 | 5.86 | Uniform |
| | | | | spherical |
| | | | | particle with |
| | | | | surface |
| | | | | protrusions |
| Example 2 | 3.5 | 51.4 | 5.40 | Uniform |
| | | | | spherical |
| | | | | particle with |
| | | | | surface |
| | | | | protrusions |
| Comparative | 3.4 | 117 | — | Angular shape |
| Example 1 | | | | |
| Comparative | 3.5 | 31 | — | Irregularly |
| Example 2 | | | | angular shape |

### Measurement of Element Content

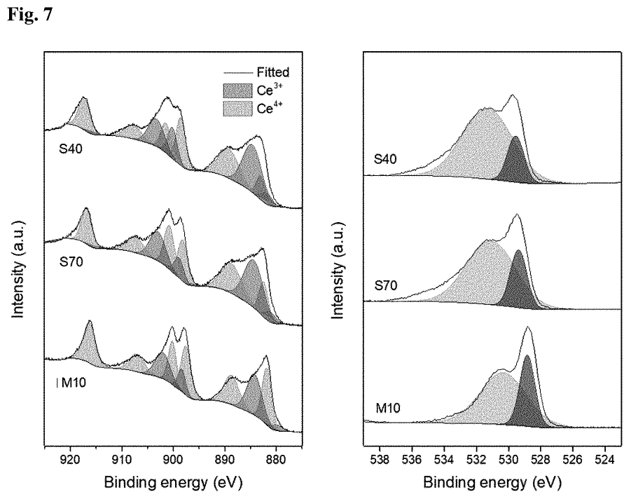

FIG. 7 shows an X-ray photoelectron spectroscopy (XPS) pattern for three sized spherical protrusion CeO₂ nanoparticle samples manufactured according to Reference Example 1, and Examples 1 and 2. The element content was calculated using the area under each peak and is shown in Table 3. For a specific method of X-ray photoelectron spectroscopy (XPS), refer to Korean Patent Application No. 10-2021-0061195.

TABLE 3

| | Peak Assignment (%) | | | | | | | |
|---|---|---|---|---|---|---|---|---|
| | Ce 3d_{3/2} | | | | | Ce 3d_{5/2} | | |
| | u₄ | u₃ | u₂ | u₁ | u₀ | v₄ | v₃ | v₂ |
| | Ce⁴⁺ | Ce⁴⁺ | Ce³⁺ | Ce⁴⁺ | Ce³⁺ | Ce⁴⁺ | Ce⁴⁺ | Ce³⁺ |
| Binding Energy (eV) | 917.29 | 907.81 | 903.30 | 901.48 | 900.18 | 898.54 | 889.23 | 884.63 |
| S40 | 9.60 | 5.94 | 11.3 | 7.43 | 7.38 | 11.4 | 15.2 | 23.3 |
| Binding Energy (eV) | 916.85 | 907.41 | 903.01 | 900.79 | 898.91 | 898.18 | 888.73 | 884.38 |
| S70 | 9.26 | 6.39 | 11.3 | 11.0 | 4.74 | 9.82 | 15.0 | 22.3 |
| Binding Energy (eV) | 916.28 | 907.08 | 902.08 | 900.18 | 898.38 | 897.53 | 888.68 | 884.23 |
| M10 | 13.3 | 6.99 | 10.2 | 9.35 | 4.60 | 12.6 | 11.4 | 16.0 |

| | Peak Assignment (%) | | | | | | |
|---|---|---|---|---|---|---|---|
| | Ce 3d_{5/2} | | | | | | |
| | v₁ | v₀ | O 1s | | Ratio (%) | | |
| | Ce⁴⁺ | Ce³⁺ | OH⁻ | O²⁻ | Ce³⁺ | Ce⁴⁺ | Ce³⁺/Ce⁴⁺ |
| Binding Energy (eV) | 882.96 | 881.82 | 531.28 | 529.55 | | | |
| S40 | 5.40 | 3.05 | 82.4 | 17.6 | 45.0 | 55.0 | 81.7 |
| Binding Energy (eV) | 882.42 | 881.14 | 531.07 | 529.37 | | | |
| S70 | 7.61 | 2.60 | 76.8 | 23.2 | 41.0 | 59.0 | 69.4 |
| Binding Energy (eV) | 881.83 | 879.88 | 530.33 | 528.83 | | | |
| M10 | 13.7 | 1.72 | 69.4 | 30.6 | 32.6 | 67.4 | 48.4 |

According to the above results, the calculated Ce³⁺ concentration of the particles of Example 1 is 41.0%, and that of Example 2 is 45.0%, which is much higher than that of the particles of Reference Example 1 at 32.6%. In addition, the ratio of Ce³⁺/Ce⁴⁺ is 69.4% for the particles of Example 1, 81.7% for the particles of Example 2, and 48.4% for the particles of Reference Example 1, indicating that the concentrations of Ce³⁺/Ce⁴⁺ on the surfaces of the particles of Examples 1 and 2 are much higher. In general, it can be seen that as the size of the spherical protrusion ceria nanoparticles decreases, the Ce³⁺/Ce⁴⁺ surface activity of the particles increases.

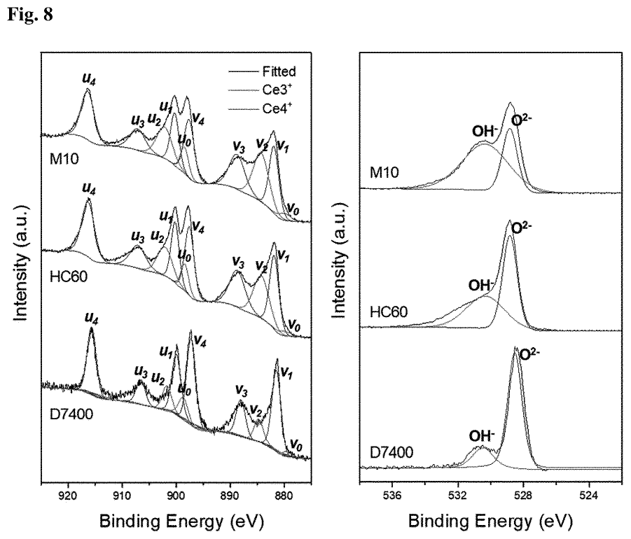

FIG. 8 shows an X-ray photoelectron spectroscopy (XPS) pattern for three sized CeO₂ nanoparticle samples according to Reference Example 1 and Comparative Examples 1 and 2. The element content was calculated using the area under each peak and is shown in Table 4.

TABLE 4

| | Peak Assignment (%) | | | | | | | |
|---|---|---|---|---|---|---|---|---|
| | Ce 3d_{3/2} | | | | | Ce 3d_{5/2} | | |
| | u₄ | u₃ | u₂ | u₁ | u₀ | v₄ | v₃ | v₂ |
| | Ce⁴⁺ | Ce⁴⁺ | Ce³⁺ | Ce⁴⁺ | Ce³⁺ | Ce⁴⁺ | Ce⁴⁺ | Ce³⁺ |
| Binding Energy (eV) | 916.28 | 907.08 | 902.08 | 900.18 | 898.38 | 897.53 | 888.68 | 884.23 |
| M10 | 13.3 | 6.99 | 10.2 | 9.35 | 4.60 | 12.6 | 11.4 | 16.0 |
| Binding Energy (eV) | 916.29 | 906.88 | 901.65 | 899.94 | 898.81 | 897.32 | 888.51 | 884.23 |
| HC60 | 14.7 | 7.35 | 8.94 | 10.1 | 4.39 | 13.4 | 12.0 | 13.8 |
| Binding Energy (eV) | 916.61 | 906.54 | 901.70 | 899.94 | 898.72 | 897.19 | 888.01 | 884.72 |
| D7400 | 15.8 | 5.71 | 5.58 | 14.0 | 4.87 | 20.3 | 8.49 | 5.25 |

| | Peak Assignment (%) | | | | | | |
|---|---|---|---|---|---|---|---|
| | Ce 3d_{5/2} | | | | | | |
| | v₁ | v₀ | O 1s | | Ratio (%) | | |
| | Ce⁴⁺ | Ce³⁺ | OH⁻ | O²⁻ | Ce³⁺ | Ce⁴⁺ | Ce³⁺/Ce⁴⁺ |
| Binding Energy (eV) | 881.83 | 879.88 | 530.33 | 528.83 | | | |
| M10 | 13.7 | 1.72 | 69.4 | 30.6 | 32.6 | 67.4 | 48.4 |
| Binding Energy (eV) | 881.56 | 879.97 | 530.33 | 528.73 | | | |
| HC60 | 14.2 | 1.13 | 47.3 | 52.7 | 28.3 | 71.7 | 39.5 |
| Binding Energy (eV) | 881.42 | 879.43 | 530.48 | 528.53 | | | |
| D7400 | 18.8 | 1.31 | 20.7 | 79.3 | 17.0 | 83.0 | 20.5 |

Even from the above results, it can be confirmed that the particles of Examples 1 and 2 according to the present invention have much higher surface-active sites and surface activity.

### Measurement of Zeta Potential

The zeta potential was measured using a zeta potential analyzer (Nano ZS) manufactured by Malvern.

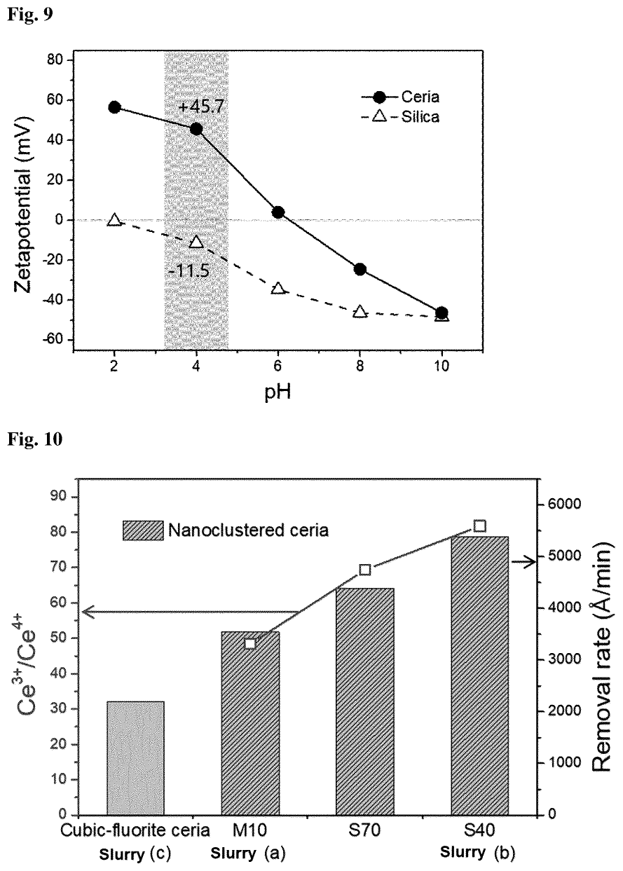

FIG. 9 is a zeta potential of the dispersion of CeO₂ nanoparticles with spherical protrusions according to Manufacturing Example 2 after adjusting the pH of the dispersion using a nitric acid solution (acidic pH adjusting agent) and ammonia water (basic pH adjusting agent). The spherical protrusion ceria nanoparticles are positively charged with a value greater than +50.0 mV at pH 2 and exhibit a weaker positive charge as the pH increases. Thereafter, it passes the point where it is neutrally charged around pH 6 and becomes negatively charged. It is confirmed that the surface charge of the nanoparticles was well controlled by adjusting the pH of the aqueous solution of ceria inorganic particles manufactured in a spherical protrusion shape. Additionally, under pH 4 condition, the particle exhibits a high zeta potential of close to +50 mV in surface charge, which has an opposite charge to the silica particles.

In addition, the zeta potentials of Reference Example 1, Example 1, Example 2, Comparative Example 1, Comparative Example 2, and silicas were measured under pH 4 condition and are shown in Table 5.

TABLE 5

| | CeO₂ | | | | | |
|---|---|---|---|---|---|---|
| | M10 | S70 | S40 | HC60 | D7400 | SiO₂ |
| Zetapotential | 45.7 | 44.2 | 42.0 | 42.1 | 43.5 | −11.5 |
| (mV) | | | | | | |

According to the above results, it is found that all five ceria nanoparticles have excellent dispersibility with zeta potential>40 mV at pH 4 and have an opposite charge to silica.

### Polishing Performance Test

The results of comparing the removal rates of silicon films through the CMP process for slurries (a) to (c) of Manufacturing Examples 1 to 3 are shown in FIG. 10. The CMP test was conducted under process conditions of slurry flow rate: 150 ml/min, pressure: 4 psi, and rotation speed (platen/pad rpm): 93/87 rpm.

As can be seen from the results in FIG. 10, compared to the commercially available cubic-fluorite shaped abrasive particles, it is confirmed that the removal rate of the abrasive ceria particles with spherical protrusions according to the present invention is generally superior, and the removal rate increases as the particle size decreases and the surface activity increases.

According to the above results, it can be seen that the surface-protruding spherical ceria (CeO₂) nanoparticles manufactured by the method according to the present invention have a uniform size and the surface charge is efficiently controlled depending on the pH. In addition, as a result of conducting a CMP test in the form of a slurry, it showed a higher level of polishing performance than the slurry with commercially available fluorite hexagonal ceria abrasive particles, and it could be confirmed that the removal rate increased as the size of the ceria decreased and the surface activity increased.

Although the above description has been focused on the embodiments of the present invention, various changes or modifications may be made at the level of those skilled in the art to which the present invention pertains. Such changes and modifications are considered to belong to the present invention as long as they do not depart from the scope of the technical spirit provided by the present invention. Accordingly, the scope of the present invention should be determined by the following claims.

1. An inorganic particle comprising:
a primary particle having a solid core and a plurality of secondary particles having a diameter smaller than that of the primary particle and forming protrusions on the surface of the primary particle,
wherein the inorganic particle has a specific surface area of 60 to 150 m²/g, surface-active sites occupying 40 to 60% of the inorganic particle surface as obtained from an element content calculated by X-ray photoelectron spectroscopy, and a total surface activity of 50 to 90% defined as the percentage of active sites to inactive sites on the surface of the inorganic particle.

2. The inorganic particle according to claim 1, wherein the—solid primary particle is grown in a shell formed by a self-assembling surfactant in the presence of a catalyst.

3. The inorganic particle according to claim 2, wherein the catalyst is at least one selected from sulfuric acid, hydrochloric acid, nitric acid, potassium hydroxide, sodium hydroxide, calcium hydroxide, magnesium hydroxide, ammonia, potassium carbonate (K₂CO₃), Fe-EDTA, EDTA-2Na, EDTA-2K, potassium dihydrogen phosphate (KH₂PO₄), potassium monohydrogen phosphate (K₂HPO₄), sodium carbonate (Na₂CO₃), sodium dihydrogen phosphate (NaH₂PO₄), and sodium monohydrogen phosphate (Na₂HPO₄).

4. The inorganic particle according to claim 1, wherein the inorganic particle has a density of 1.5 to 7.5 g/ml and an average diameter of 30 to 1000 nm.

5. The inorganic particle according to claim 1, wherein the secondary particles have a diameter of 2 to 25% of the diameter of the primary particle.

6. The inorganic particle according to claim 1, wherein the secondary particles are amorphous or crystalline, wherein the inorganic particle has a degree of crystallinity of 50 to 90%.

7. The inorganic particle according to claim 1, wherein the inorganic particle has a zeta potential of +30 to +50 mV or −30 to −50 mV in an aqueous dispersion at pH 4.

8. The inorganic particle according to claim 1, wherein the primary particle and the secondary particles are each independently composed of an oxide of one or more selected from the group consisting of Ga, Sn, As, Sb, Ce, Si, Al, Co, Fe, Li, Mn, Ba, Ti, Sr, V, Zn, La, Hf, Ni and Zr.

9. A method for manufacturing the inorganic particle according to claim 1, comprising the steps of:
(a) dissolving a self-assembling surfactant and a catalyst in a solvent;
(b) dissolving or dispersing an inorganic precursor in the solvent before, after, or simultaneously with the step (a) to prepare an inorganic precursor solution; and
(c) forming a solid primary particle in a shell formed through a self-assembly reaction between the inorganic precursor and the self-assembling surfactant, and then forming a plurality of secondary particles having a diameter smaller than that of the primary particle as protrusions on the surface of the primary particle.

10. The method for manufacturing the inorganic particle according to claim 9, further comprising treating the inorganic particle obtained in step (c) with an acid and a base to obtain the inorganic particle having a controlled surface charge.

11. The method for manufacturing the inorganic particle according to claim 9, wherein the self-assembling surfactant is at least one selected from a cationic surfactant, an anionic surfactant and an amphoteric surfactant, having a charge capable of bonding with the inorganic precursor and having a functional group capable of a condensation reaction or cross-linking reaction.

12. The method for manufacturing the inorganic particle according to claim 11, wherein the functional group capable of the condensation reaction or cross-linking reaction is at least one selected from the group consisting of an amido group, a nitro group, an aldehyde group, and a carbonyl group.

13. The method for manufacturing the inorganic particle according to claim 9, wherein the self-assembling surfactant is a compound of the following chemical formula 1: 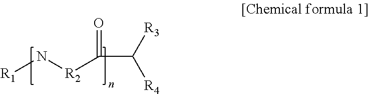
wherein, R₁, R₃, and R₄ are each independently a hydrogen atom, a C₁-C₁₀ alkyl group, or an alkoxy group, R₂ is a C₂-C₁₀ alkylene group or a single covalent bond, and n is an integer greater than or equal to 2.

14. An aqueous dispersion comprising the inorganic particles of claim 1 dispersed in water.

15. A slurry for CMP containing the aqueous dispersion of claim 14.
